(19) United States
(12) Patent Application Publication
(10) Pub. No.: US 2002/0178602 A1
(43) Pub. Date: Dec. 5, 2002

(54) System and method for measuring the thickness of material layers applied in the funnel of a cathode ray tube during manufacture

(75) Inventors: David Allen Murtishaw, Sun City, CA (US); Michael Gerald King, Poway, CA (US); Marcio Antonio Chinn, San Diego, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(73) Assignee: Sony Corporation and Sony Electronics Inc.

(21) Appl. No.: 09/873,610

(22) Filed: Jun. 4, 2001

(51) Int. Cl. G01B 5/06

(52) U.S. Cl. 33/834

(57) ABSTRACT

A hand tool can be used for measuring the thickness of a carbon layer applied in a cathode ray tube funnel during manufacture of the tube. The hand tool includes a scribe with a cutting blade or point that extends under the control of the user relative to the rest of the tool. The extension of the scribe relative to the base of the tool, which may be a roller, rollers or a skid plate, indicates the thickness of the carbon layer. The tool can also be applied to measure the thickness of other material layers deposited on a substrate.

### FIELD OF THE INVENTION

The present invention relates to the field of manufacturing cathode ray tubes. More specifically, the present invention relates to the field of applying carbon material inside the funnel of a cathode ray tube during the manufacture of the tube.

The present invention provides a method and tool for measuring the thickness of the carbon layer after application to ensure that the layer is within the optimal thickness range.

### BACKGROUND OF THE INVENTION

Cathode ray tubes (“CRTs”) are used in most television sets, computer monitors and other video monitors. A typical CRT is illustrated in FIG. 1. The CRT (100) is a glass tube with a bottle-like shape in which a relatively flat bottom portion (101) narrows into an elongated neck portion (102). The relatively flat portion (101) of the CRT (100) becomes the screen on which the display of the television set or monitor is generated when the CRT is incorporated therein. An electroluminescent material, such as phosphorus, that emits light when struck by an electron beam, is coated over the interior of the screen portion (101) of the CRT (100).

An electron gun (not shown) is then installed in the neck (102) of the CRT (100). A stream of electrons emitted from the electron gun is scanned over the electro-luminescent layer and turned on and off during the scanning to cause the electro-luminescent layer to glow in certain places and not others. In very simple terms, this is how an image is generated on the screen of a television or video monitor.

A yoke (not shown) is provided around the neck (102) of the CRT (100). This yoke produces a changing magnetic field through which the electron beam from the electron gun passes. The electron beam is deflected by the magnetic field of the yoke. Consequently, by varying the magnetic field created by the yoke in a precise cycle, the electron beam can be scanned, line-by-line, over the entire surface of the screen to generate video images thereon.

A cathode ray tube is generally constructed in the following matter. The neck (102) or funnel portion of the CRT (100) is formed open at both ends. Then the relatively flat bottom, or display portion (101) is sealed to the large end of the funnel and the electron gun is installed in the narrow end or neck of the funnel.

The display portion (101) is sealed to the funnel (102) using frit. Frit is a glass paste that can be cured or hardened. Frit (103), in paste form, is applied around the large end of the funnel (102) between the funnel (102) and the display portion (101). The frit is cured or hardened to form a frit seal (103) between the funnel (102) and the display portion (101).

Before the funnel (102) and display (101) portions are sealed, coatings are applied to the interior of the funnel (102). These coatings include a layer of carbon material necessary to the optimal operation of the CRT (100). FIG. 2 illustrates a carbon layer application station in a cathode ray tube production line.

As shown in FIG. 2, cathode ray tube funnels (102) are supported during processing on holders or pallets (200). The pallets (200) include a base (201) with supports (202) that hold the funnel (102) in an upright position with the open, large end of the funnel (102) pointing upward. The pallets (200) carrying the funnels (102) may be transported on a conveyor (203).

Each funnel (102) is brought to the coating application station (205). At the coating application station (205), the coating of carbon material is sprayed into the interior of the funnel (102). A spray head (204) sprays the coating into the open interior of the funnel (102) as the funnel (102) is supported on the pallet (200). Then, the funnel (102) is conveyed into and through a drying oven (206) to dry the newly-applied coating.

The carbon layer on the interior of the funnel provides a necessary electrical path for the high voltages that occurs inside the CRT (100) during its operation. The carbon layer has a resistance that depends on this thickness and other properties. Because the resistance of the carbon layer is important to the use of the carbon layer as a high-voltage electrical path, it is important to ensure that the layer of carbon applied has a thickness within an optimal range.

However, in the past, there has been no ready means of verifying that the layer of carbon material has been applied to the correct thickness. Consequently, there is a need in the art for a means and method of measuring the thickness of the carbon layer applied to the interior of a cathode ray tube funnel during manufacture to verify that the thickness of the carbon layer falls within an optimal range.

### SUMMARY OF THE INVENTION

The present invention meets the above-described needs and others. Specifically, the present invention provides a means and method of measuring the thickness of the carbon layer applied to the interior of a cathode ray tube funnel during manufacture to verify that the thickness of the carbon layer falls within an optimal range.

Additional advantages and novel features of the invention will be set forth in the description which follows or may be learned by those skilled in the art through reading these materials or practicing the invention. The advantages of the invention may be achieved through the means recited in the attached claims.

The present invention may be embodied and described as a tool for measuring the depth or thickness of a layer of material applied on a substrate. The tool preferably includes: a carriage; a scribe supported by the carriage; and a control device for the scribe that extends the scribe relative to the tool. By adjusting a position of the scribe using the control device, the depth or thickness of the layer of material is determined.

In a particularly preferred embodiment, the control device is a knob with a threaded passage therethrough that receives a threaded shaft on which the scribe is supported. Preferably, the control device also provides an indicator for indicating the displacement of the scribe relative to the tool.

The carriage is preferably supported on at least one roller or skid plate. The carriage also preferably includes a handle to facilitate manipulation of the tool.

In a particularly preferred application for the tool of the present invention, the layer of material is a layer of carbon material and the substrate is an interior of a cathode ray tube funnel. The need for the tool of the present invention in this application is explained below.

The present invention also encompasses the methods of making and using the tool described above. Specifically, the present invention encompasses a method of measuring the depth or thickness of a layer of material applied on a substrate with a tool comprising a scribe supported on a carriage. This method is performed by adjusting the position of the scribe relative to the tool until displacement of the scribe indicates the depth or thickness of the layer of material.

In one embodiment, the method includes moving the tool over the layer of material, where the position of the scribe is adjusted until the scribe cuts through the layer of material to the underlying substrate when the tool is moved over the layer of material. The displacement of the scribe then indicates the depth or thickness of the layer of material.

In a second embodiment, the method includes moving the tool over an exposed portion of the substrate adjacent to an edge of the layer of material, where the position of the scribe is adjusted until the scribe initially contacts the layer of material. The displacement of the scribe then indicates the depth or thickness of the layer of material.

In either embodiment, the moving of the tool may be performed by rolling the tool over the layer of material or the exposed substrate on at least one roller. The roller or rollers support the carriage of the tool. The displacement of the scribe is a vertical distance between the end of the scribe and the roller or rollers.

Adjusting the position of the scribe may be performed with the knob and threaded passage mentioned above that receives a threaded shaft on which the scribe is supported. The method of the present invention also preferably comprises reading an indicator that indicates the depth or thickness of the layer of material based on the displacement of the scribe relative to the tool.

As noted above, the tool and method of the present invention are specifically designed to apply to measuring the depth or thickness of a layer of carbon material applied on the interior of a cathode ray tube funnel.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is an illustration of a typical cathode ray tube to the manufacture of which the present invention can be profitably applied.

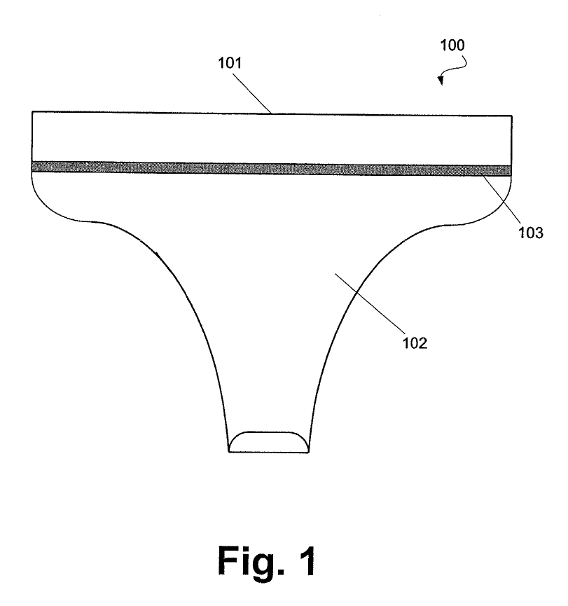

FIG. 2 is an illustration of a system for applying a carbon layer to the interior of cathode ray tube funnel during manufacturing.

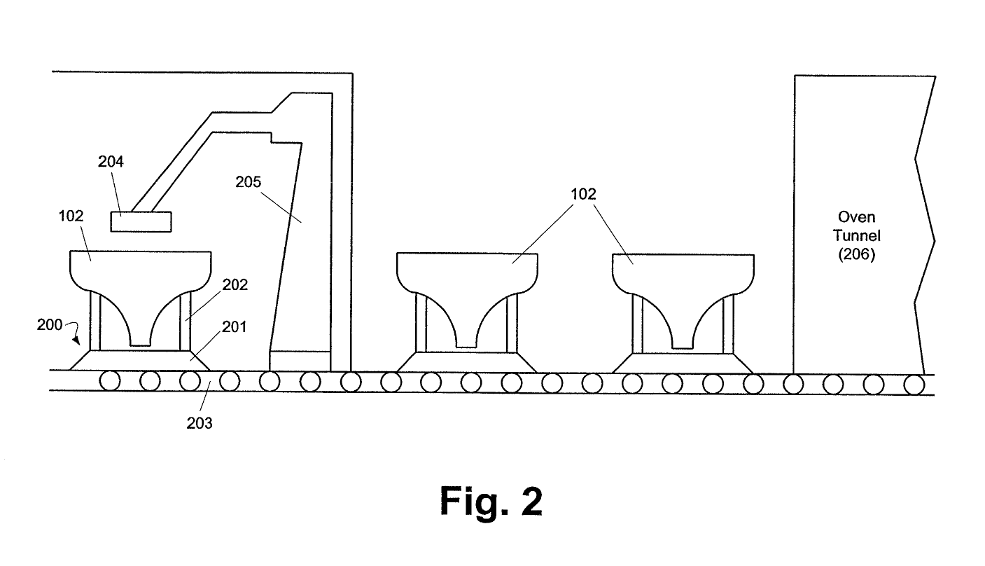

FIG. 3 is an illustration of a first embodiment of a carbon thickness measuring tool according to the principles of the present invention.

FIG. 4 is an illustration of the tool of FIG. 3 in use according to the principles of the present invention.

FIG. 5 is an illustration of a second embodiment of the carbon thickness measuring tool of the present invention.

FIG. 6 is a flowchart illustrating a preferred method of using the carbon thickness measuring tool of the present invention in either embodiment.

Throughout the drawings, identical elements are designated by identical reference numbers.

### DETAILED DESCRIPTION OF THE PREFERRED EMBODIMENTS

In broad general principle, the present invention includes a hand tool for measuring the thickness of a carbon layer applied in a Cathode Ray Tube (“CRT”) funnel during manufacture of the tube. The hand tool includes a scribe with a cutting blade or point that extends under the control of the user relative to a roller or wheels. The extension of the scribe relative to the roller or wheels indicates the thickness of the carbon layer as will be described in detail below.

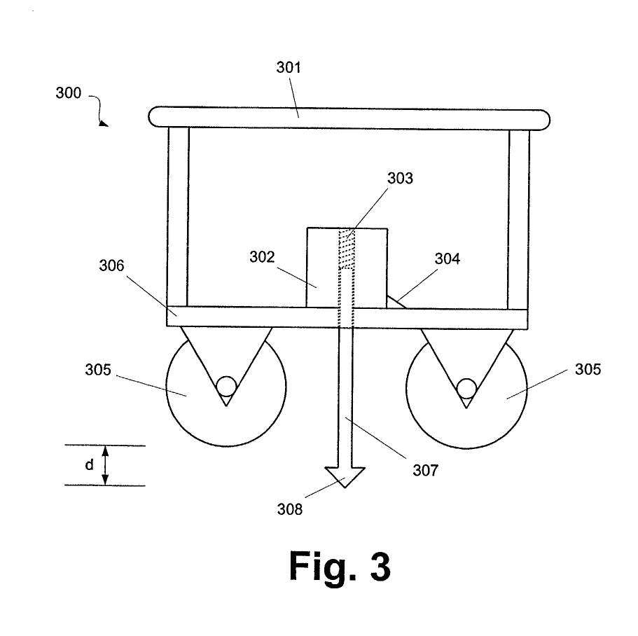

Using the drawings, the preferred embodiments of the present invention will now be explained. FIG. 3 is an illustration of a first embodiment of a carbon thickness measuring tool according to the principles of the present invention. As shown in FIG. 3, the tool includes a blade or scribe (308) that can be used to cut through a dried carbon or other material layer deposited on a substrate, such as the interior of a CRT funnel. This scribe (308) is supported on a shaft (307) which is, in turn, supported by a carriage (306).

The carriage (306) preferably has a roller for allowing the carriage to move over a layer of carbon or other material layer being measured. In FIG. 3, a preferred embodiment is illustrated in which the carriage (306) is mounted on two rollers (305). However, a single or more than two rollers could be used within the principles of the present invention. Additionally, while a roller or rollers are preferred, the carriage (306) could also be mounted on, or incorporate, a skid plate or plates for sliding over the carbon or other material layer being measured.

In order for the scribe (308) to be used to measure the depth or thickness of a carbon or other material layer, the scribe (308) must be movable relative to the roller or rollers (305). As the carriage (306) is moved over the carbon or other material layer, the tip of the scribe (308) cuts into the layer. When the scribe (308) cuts completely through the layer so that the underlying substrate is exposed, the distance (d) between the tip of the scribe (308) and the bottom of the rollers (305) equals the depth or thickness of the layer being measured.

To effect this relative movement between the scribe (308) and the rollers (305), FIG. 3 illustrates a preferred embodiment in which the shaft (307) of the scribe (308) is threaded and passes through a threaded passage (303) in a knob (302) on the carriage (306). An indicator (304) on the knob (302) moves with the knob (302) and, therefore, tracks the distance the knob (302) is rotated. This rotation is, in turn, correlated to the vertical distance that such rotation moves the shaft (307) and the scribe (308). The indicator (304) thus provides the distance (d) between the tip of the scribe (308) and the bottom of the rollers (305). This distance is preferably given in micrometers.

The indicator (304) may make its indication of distance (d) using a printed or stamped scale of distances that appears on the carriage (306). Alternatively, more sophisticated means of translating a rotational movement into a measurement of linear movement, without or without an intervening gear system, may be used within the scope of the present invention. Such related translation systems are known in other fields, for example, the field of power tools, and can be adapted for use here under the principles of the present invention.

Finally, as shown in FIG. 3, the tool (300) of the present invention may include a handle (301). The handle (301) allows the tool (300) to be readily controlled and moved over the material layer being measured. Some pressure applied, for example, through the handle (301) may be needed to allow the scribe (308) to score or cut through the material layer being measured.

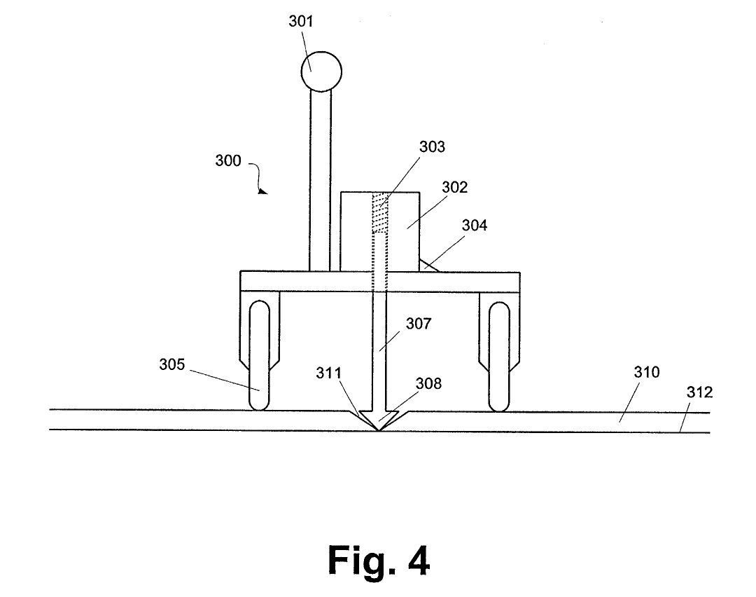

FIG. 4 is an end-on view of the tool (300) described above and illustrates the tool in use according to the principles of the present invention. As shown in FIG. 3, the tool (300) is moved across the layer of material to be measured. In the illustrated embodiment, the layer of material (310) being measured is a dried carbon layer applied to the interior of a CRT funnel (312).

As shown in FIG. 4, the tool (300) is moved across the carbon layer (310). The rollers (305) ride on the top of the carbon layer (310) and the scribe (308) gouges or scores a cut (311) in the carbon layer (310). The height of the scribe (308) is adjusted using the knob (302) until the scribe (308) is cutting completely through the carbon layer (310) and riding on the underlying glass substrate (312) of the CRT funnel.

When the height of the scribe (308) is adjusted to this point, the distance between the end of the scribe (308) and the bottom of the rollers (305) equals the depth or thickness of the carbon layer (310). Consequently, by reading this relative distance between the end of the scribe (308) and the bottom of the rollers (305) using the indicator (304), as described above, the depth or thickness of the carbon layer (310) can be precisely and accurately measured.

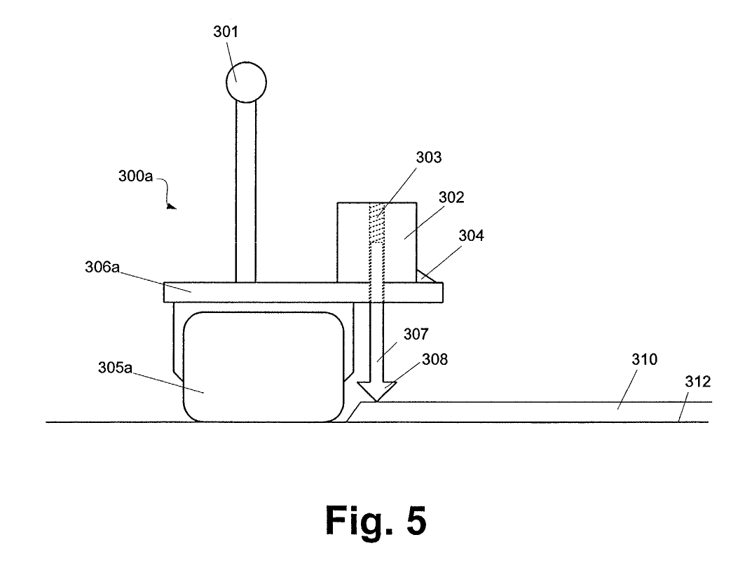

FIG. 5 is an illustration of a second embodiment of the carbon thickness measuring tool of the present invention. The principal difference between the first and second embodiments may be explained as follows. As noted above, the rollers (305) of the first embodiment ride over the layer of material being measured when the tool (300) is used. In contrast, the second embodiment provides a tool (300a) in which the roller (305a) does not ride on the material layer being measured, but rather rides on an exposed portion of the underlying substrate next to the material layer being measured. For some applications, this form of the tool of the present invention may provide additional advantages.

As shown in FIG. 5 and as will be described here in detail, it is possible to measure the thickness of the carbon layer (310) without the tool (300a) being moved on the carbon layer (310). Rather, the tool (300a) moves over an exposed portion of the underlying substrate next to the material layer being measured. For this embodiment a single, wider roller (305a) is preferred as shown in FIG. 5.

The carriage (306a) extends out away from the roller (305a) so as to hang over the edge of the material layer (310) being measured while the roller (305a) rides on the exposed CRT funnel (312). The scribe (308) and shaft (307) are preferably supported from the portion of the carriage (306a) that extends over the material layer (310). The knob (302) and indicator (304) may also be disposed on the portion of the carriage (306a) that extends over the material layer (310).

With the scribe (308) suspended over the material layer (310), as shown in FIG. 5, the depth or thickness of the layer (310) can again be measured by monitoring the relative distance between the end of the scribe (308) and the bottom of the roller or rollers (305a). In this case, the height of the scribe (308) is adjusted until the tip of the scribe (308) rides over the material layer (310) without substantially scoring the layer (310).

When the height of the scribe (308) is so adjusted, the distance between the tip of the scribe (308) and the bottom of the roller(s) (305a) gives the depth or thickness of the material layer (310). The indicator (304) is preferably calibrated as necessary to indicate the distance between the scribe (308) and roller (305a) as a positive distance as compared with the manner in which the indicator (304) would be calibrated in the first embodiment described above.

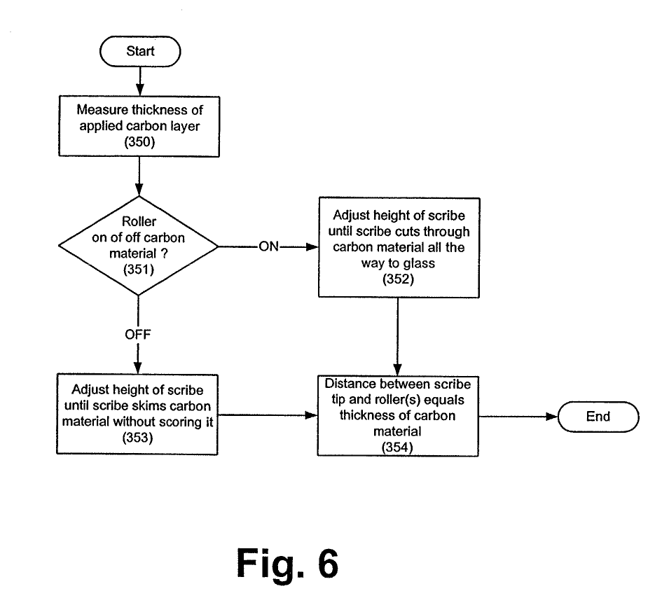

FIG. 6 is a flowchart illustrating a preferred method of using the carbon thickness measuring tool of the present invention in either embodiment. As shown in FIG. 6, the method beings with the need to measure the depth or thickness of an applied and dried layer of carbon material in a CRT funnel (350).

First, it must be determined if the roller(s) or skid plate(s) of the tool will ride on or off the layer of carbon material being measured (351). If the tool will ride on the layer, a tool according to the first embodiment described above should be used. Conversely, if the tool will ride on an exposed portion of the funnel glass, a tool according to the second embodiment described above should be used.

If the tool will ride on the material layer, the height of the scribe relative to the bottom of the roller(s) or skid plate(s) is adjusted until the scribe cuts completely through the carbon layer to expose the CRT funnel glass below (352). If, instead, the tool will ride an exposed portion of the funnel glass, the height of the scribe relative to the bottom of the roller(s) or skid plate(s) is adjusted until rides over the material layer without significantly cutting or scoring the layer (353).

In either case, the measured distance between the adjusted scribe and the bottom of the roller(s) or skid plate(s) equals with good accuracy the thickness or depth of the layer of carbon material being measured (354). As noted above, the indicator adjusted to the controls for adjusting the height of the scribe should be calibrated to give a positive reading in each embodiment.

In this way, the tool of the present invention can be used to quickly and accurately confirm the depth or thickness of the carbon layer applied inside the funnel of a CRT being manufactured. This, in turn, will improve the quality and reliability of the CRTs being produced.

The preceding description has been presented only to illustrate and describe the invention. It is not intended to be exhaustive or to limit the invention to any precise form disclosed. Many modifications and variations are possible in light of the above teaching. For example, the tool can be used to measure the depth or thickness of other layers of material provided that, there is an exposed portion of the underlying substrate for the tool to ride on or the layer of material can be cut through with a scribe as described above.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A tool for measuring a depth or thickness of a layer of material applied on a substrate, said tool comprising:
a carriage
a scribe supported by said carriage; and
a control device for said scribe that extends said scribe relative to said tool;
wherein said by adjusting a position of said scribe using said control device, said depth or thickness of said layer of material is determined.

2. The tool of claim 1, wherein said control device comprises an indicator for indicating a displacement of said scribe relative to said tool.

3. The tool of claim 1, wherein said control device is a knob with a threaded passage therethrough that receives a threaded shaft on which said scribe is supported.

4. The tool of claim 1, wherein said carriage is supported on at least one roller.

5. The tool of claim 1, wherein said carriage further comprises a handle.

6. The tool of claim 1, wherein said layer of material is a layer of carbon material and said substrate is an interior of a cathode ray tube funnel.

7. A method of measuring a depth or thickness of a layer of material applied on a substrate with a tool comprising a scribe supported on a carriage, said method comprising adjusting a position of said scribe relative to said tool until displacement of said scribe indicates said depth or thickness of said layer of material.

8. The method of claim 7, further comprising moving said tool over said layer of material, wherein said adjusting said position of said scribe comprises adjusting said position of said scribe until said scribe cuts through said layer of material to said underlying substrate when said tool is moved over said layer of material, said displacement of said scribe then indicating said depth or thickness of said layer of material.

9. The method of claim 8, wherein said moving said tool over said layer of material further comprises rolling said tool over said layer of material on at least one roller supporting said carriage.

10. The method of claim 9, wherein said displacement of said scribe is a vertical distance between an end of said scribe and said at least one roller.

11. The method of claim 7, further comprising moving said tool over an exposed portion of said substrate adjacent to an edge of said layer of material, wherein said adjusting said position of said scribe comprises adjusting said position of said scribe until said scribe initially contacts said layer of material, said displacement of said scribe then indicating said depth or thickness of said layer of material.

12. The method of claim 11, wherein said moving said tool over said exposed substrate further comprises rolling said tool over said exposed substrate on at least one roller supporting said carriage.

13. The method of claim 12, wherein said displacement of said scribe is a vertical distance between an end of said scribe and said at least one roller.

14. The method of claim 7, wherein said adjusting said position of said scribe comprises adjusting said position of said scribe until said scribe initially contacts said layer of material, said displacement of said scribe then indicating said depth or thickness of said layer of material; wherein a base of said tool rests on an exposed portion of said substrate and said displacement of said scribe is a vertical distance between an end of said extended scribe and said base.

15. The method of claim 7, wherein said adjusting said position of said scribe is performed with a knob with a threaded passage that receives a threaded shaft on which said scribe is supported.

16. The method of claim 7, further comprising reading an indicator that indicates said depth or thickness of said layer of material based on said displacement of said scribe relative to said tool.

17. The method of claim 7, further comprising measuring a depth or thickness of a layer of carbon material applied on an interior of a cathode ray tube funnel.

18. A device for measuring a depth or thickness of a layer of material applied on a substrate, said device comprising:
a scribe supported on a carriage; and
means for adjusting a position of said scribe supported on said carriage until displacement of said scribe indicates said depth or thickness of said layer of material.

19. The device of claim 18, further comprising means for moving said tool over said layer of material, wherein said means for adjusting said position of said scribe is operated until said scribe cuts through said layer of material to said underlying substrate, said displacement of said scribe then indicating said depth or thickness of said layer of material.

20. The device of claim 19, wherein said means for moving said tool over said layer of material further comprises at least one roller supporting said carriage.

21. The device of claim 20, wherein said displacement of said scribe is a vertical distance between an end of said scribe and said at least one roller.

22. The device of claim 18, further comprising means for moving said tool over an exposed portion of said substrate adjacent to an edge of said layer of material, wherein said means for adjusting said position of said scribe is operated until said scribe initially contacts said layer of material, said displacement of said scribe then indicating said depth or thickness of said layer of material.

23. The device of claim 22, wherein said means for moving said tool over said layer of material further comprises at least one roller supporting said carriage.

24. The device of claim 23, wherein said displacement of said scribe is a vertical distance between an end of said scribe and said at least one roller.

25. The device of claim 18, wherein said means for adjusting said position of said scribe comprise a knob with a threaded passage that receives a threaded shaft on which said scribe is supported.

26. The device of claim 18, further comprising means for indicating said depth or thickness of said layer of material based on said displacement of said scribe relative to said tool.

27. The device of claim 18, wherein said device provides a means for measuring a depth or thickness of a layer of carbon material applied on an interior of a cathode ray tube funnel.
